(19) United States
(12) Patent Application Publication
(10) Pub. No.: US 2024/0187041 A1
(43) Pub. Date: Jun. 6, 2024

(54) INDICATION OF RECONFIGURABLE INTELLIGENT SURFACE PARTICIPATION IN A COMMUNICATION

(71) Applicant: QUALCOMM Incorporated, San Diego, CA (US)

(72) Inventors: Ahmed ELSHAFIE, San Diego, CA (US); Saeid SAHRAEI, San Diego, CA (US); Yu ZHANG, San Diego, CA (US); Hung Dinh LY, San Diego, CA (US)

(21) Appl. No.: 18/555,128

(22) PCT Filed: Jun. 18, 2021
(86) PCT No.: PCT/CN2021/100822

§ 371 Date: Oct. 12, 2023

(51) Int. Cl. H04B 7/04; H04B 7/06; H04L 5/00; H04W 76/20

(52) U.S. Cl. CPC H04B 7/04013; H04B 7/0617; H04L 5/0051; H04W 76/20

(57) ABSTRACT

Various aspects of the present disclosure generally relate to wireless communication. In some aspects, a controller of a reconfigurable intelligent surface (RIS) may receive a signal including a plurality of demodulation reference signals (DMRSs). The controller of the RIS may configure a set of reflective elements of the RIS such that a first DMRS of the plurality of DMRSs is reflected using a first beamformer and a second DMRS of the plurality of DMRSs is reflected using a second beamformer different than the first beamformer. Numerous other aspects are described.

### FIELD OF THE DISCLOSURE

Aspects of the present disclosure generally relate to wireless communication and to techniques and apparatuses for indication of reconfigurable intelligent surface (RIS) participation in a communication.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. NR, which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a controller of a reconfigurable intelligent surface (RIS) includes receiving a signal including a plurality of demodulation reference signals (DMRSs); and configuring a set of reflective elements of the RIS such that, a first DMRS of the plurality of DMRSs is reflected using a first beamformer and a second DMRS of the plurality of DMRSs is reflected using a second beamformer different than the first beamformer.

In some aspects, a method of wireless communication performed by an apparatus of a user equipment (UE) includes receiving configuration information indicating that signals associated with DMRSs having different phases are associated with a RIS; receiving a signal including a plurality of DMRSs, wherein a first DMRS of the plurality of DMRSs is associated with a first phase and a second DMRS of the plurality of DMRSs is associated with a second phase different than the first phase; and performing a communication based at least in part on the first DMRS and the second DMRS having different phases.

In some aspects, a method of wireless communication performed by an apparatus of a base station includes transmitting, to a controller of a RIS, first configuration information indicating to configure a set of reflection coefficients for a set of reflective elements of the RIS such that a first DMRS of a plurality of DMRSs of a signal is reflected with a first beamformer and a second DMRS of the plurality of DMRSs is reflected with a second beamformer, wherein the first beamformer is associated with a first phase and the second beamformer is associated with a second phase; and transmitting, to a UE, second configuration information indicating that signals associated with the first DMRS having the first phase and the second DMRS having the second phase are associated with the surface reflective of radio frequency signals.

In some aspects, a controller of a RIS for wireless communication includes a memory; and one or more processors, coupled to the memory, configured to: receive a signal including a plurality of DMRSs; and configure a set of reflective elements of the RIS such that a first DMRS of the plurality of DMRSs is reflected using a first beamformer and a second DMRS of the plurality of DMRSs is reflected using a second beamformer different than the first beamformer.

In some aspects, an apparatus of a wireless node for wireless communication includes a memory; and one or more processors, coupled to the memory, configured to: receive configuration information indicating that signals associated with DMRSs having different phases are associated with a RIS; receive a signal including a plurality of DMRSs, wherein a first DMRS of the plurality of DMRSs is associated with a first phase and a second DMRS of the plurality of DMRSs is associated with a second phase different than the first phase; and perform a communication based at least in part on the first DMRS and the second DMRS having different phases.

In some aspects, an apparatus of a wireless node for wireless communication includes a memory; and one or more processors, coupled to the memory, configured to: transmit, to a controller of a RIS, first configuration information indicating to configure a set of reflection coefficients for a set of reflective elements of the surface such that a first DMRS of a plurality of DMRSs of a signal is reflected with a first beamformer and a second DMRS of the plurality of DMRSs is reflected with a second beamformer, wherein the first beamformer is associated with a first phase and the second beamformer is associated with a second phase; and transmit, to a UE, second configuration information indicating that signals associated with the first DMRS having the first phase and the second DMRS having the second phase are associated with the surface reflective of radio frequency signals.

In some aspects, a non-transitory computer-readable medium storing a set of instructions for wireless communication includes one or more instructions that, when executed by one or more processors of a controller of a RIS, cause the controller to: receive a signal including a plurality of DMRSs; and configure a set of reflective elements of the RIS such that a first DMRS of the plurality of DMRSs is reflected using a first beamformer and a second DMRS of the plurality of DMRSs is reflected using a second beamformer different than the first beamformer.

In some aspects, a non-transitory computer-readable medium storing a set of instructions for wireless communication includes one or more instructions that, when executed by one or more processors of an apparatus of a wireless node, cause the apparatus to: receive configuration information indicating that signals associated with DMRSs having different phases are associated with a RIS; receive a signal including a plurality of DMRSs, wherein a first DMRS of the plurality of DMRSs is associated with a first phase and a second DMRS of the plurality of DMRSs is associated with a second phase different than the first phase; and perform a communication based at least in part on the first DMRS and the second DMRS having different phases.

In some aspects, a non-transitory computer-readable medium storing a set of instructions for wireless communication includes one or more instructions that, when executed by one or more processors of an apparatus of a wireless node, cause the apparatus to: transmit, to a controller of a RIS, first configuration information indicating to configure a set of reflection coefficients for a set of reflective elements of the surface such that a first DMRS of a plurality of DMRSs of a signal is reflected with a first beamformer and a second DMRS of the plurality of DMRSs is reflected with a second beamformer, wherein the first beamformer is associated with a first phase and the second beamformer is associated with a second phase; and transmit, to a UE, second configuration information indicating that signals associated with the first DMRS having the first phase and the second DMRS having the second phase are associated with the surface reflective of radio frequency signals.

In some aspects, an apparatus of a RIS for wireless communication includes means for receiving a signal including a plurality of DMRSs; and means for configuring a set of reflective elements of the RIS such that a first DMRS of the plurality of DMRSs is reflected using a first beamformer and a second DMRS of the plurality of DMRSs is reflected using a second beamformer different than the first beamformer.

In some aspects, an apparatus of a wireless node for wireless communication includes means for receiving configuration information indicating that signals associated with DMRSs having different phases are associated with a RIS; means for receiving a signal including a plurality of DMRSs, wherein a first DMRS of the plurality of DMRSs is associated with a first phase and a second DMRS of the plurality of DMRSs is associated with a second phase different than the first phase; and means for performing a communication based at least in part on the first DMRS and the second DMRS having different phases.

In some aspects, an apparatus of a wireless node for wireless communication includes means for transmitting, to a controller of a RIS, first configuration information indicating to configure a set of reflection coefficients for a set of reflective elements of the surface such that a first DMRS of a plurality of DMRSs of a signal is reflected with a first beamformer and a second DMRS of the plurality of DMRSs is reflected with a second beamformer, wherein the first beamformer is associated with a first phase and the second beamformer is associated with a second phase; and means for transmitting, to a UE, second configuration information indicating that signals associated with the first DMRS having the first phase and the second DMRS having the second phase are associated with the surface reflective of radio frequency signals.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example associated with a surface and a controller of a reconfigurable intelligent surface (RIS), in accordance with the present disclosure.

FIG. 6 is a diagram illustrating an example associated with circumventing an obstruction using an RIS, in accordance with the present disclosure.

FIGS. 7 and 8 are diagrams illustrating examples associated with an indication of RIS participation in a communication, in accordance with the present disclosure.

FIGS. 9-11 are diagrams illustrating example processes associated with an indication of RIS participation in a communication, in accordance with the present disclosure.

FIGS. 12-14 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

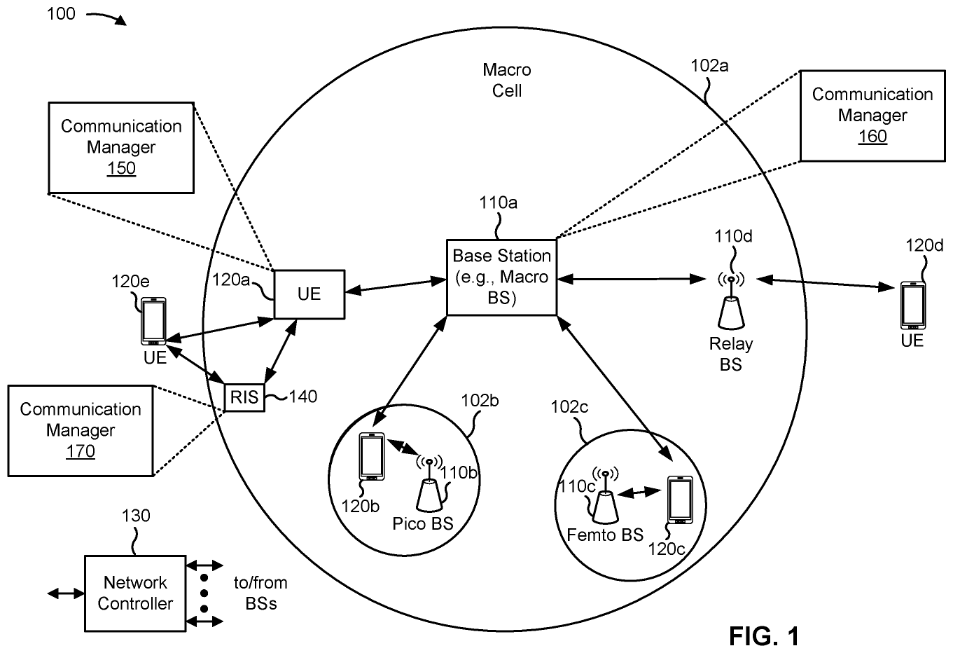

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

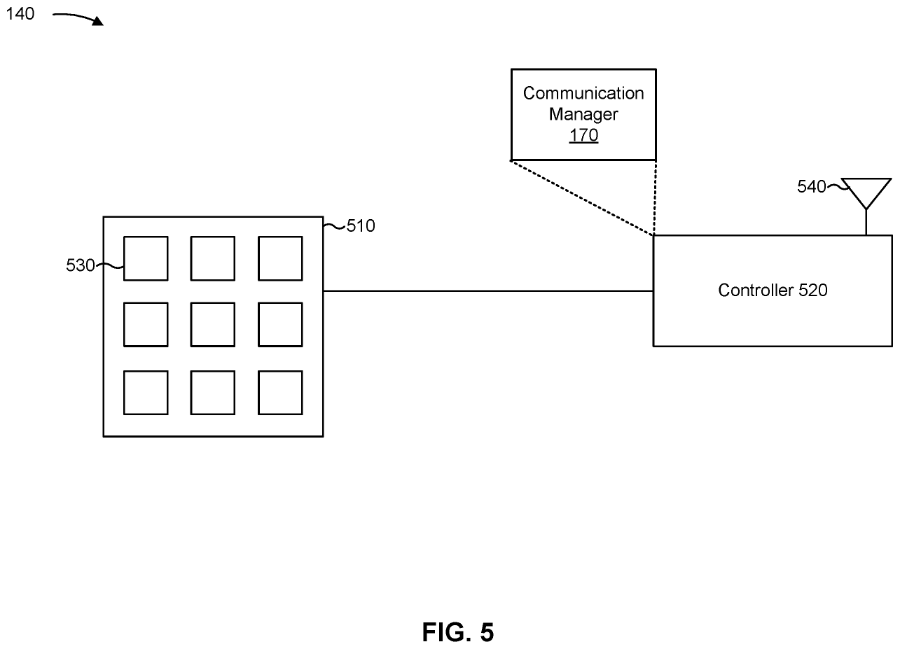

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110. In some aspects, a reconfigurable intelligent surface (RIS) 140 may relay or reflect transmissions between UEs 120 or between a UE 120 and a base station 110. The RIS 140 is described in more detail in connection with FIG. 5.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 150. As described in more detail elsewhere herein, the communication manager 150 may perform one or more operations associated with indication of RIS participation in a communication. Additionally, or alternatively, the communication manager 150 may perform one or more other operations described herein.

In some aspects, the base station 110 may include a communication manager 160. As described in more detail elsewhere herein, the communication manager 160 may perform one or more operations associated with indication of RIS participation in a communication. Additionally, or alternatively, the communication manager 160 may perform one or more other operations described herein.

In some aspects, the RIS 140 may include a communication manager 170. As described in more detail elsewhere herein, the communication manager 170 may perform one or more operations associated with indication of RIS participation in a communication. Additionally, or alternatively, the communication manager 170 may perform one or more other operations described herein.

As indicated above, FIG. 1 is provided as an example. Other examples may differ from what is described with regard to FIG. 1.

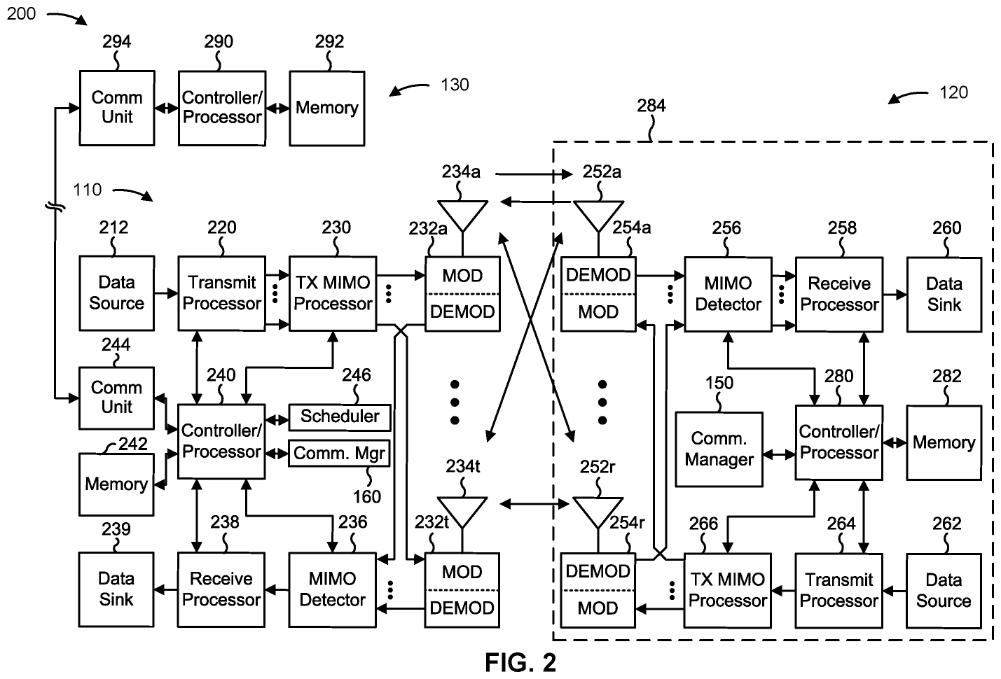

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The UE 120 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

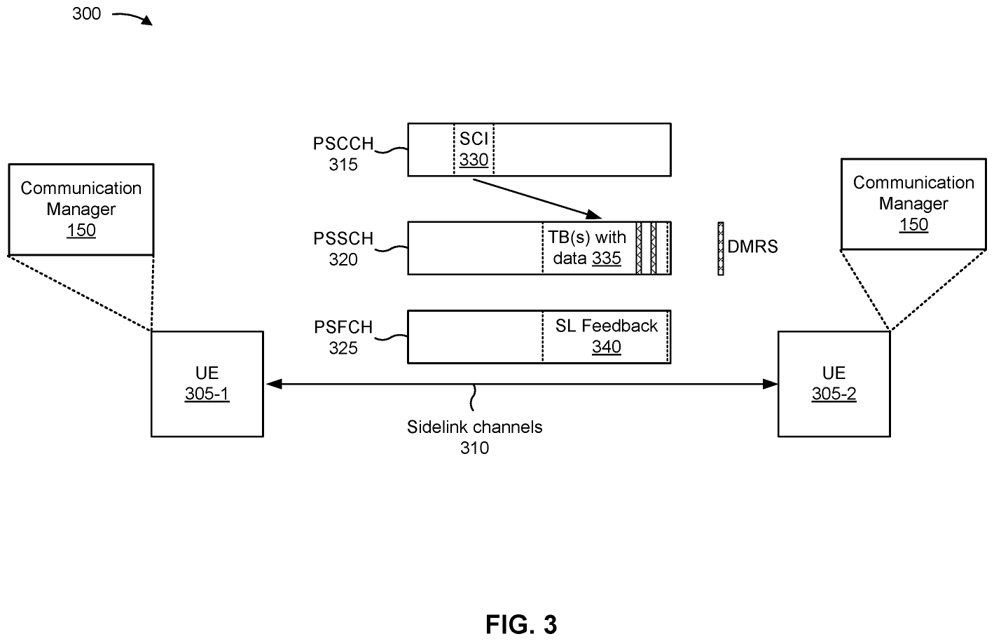

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-11).

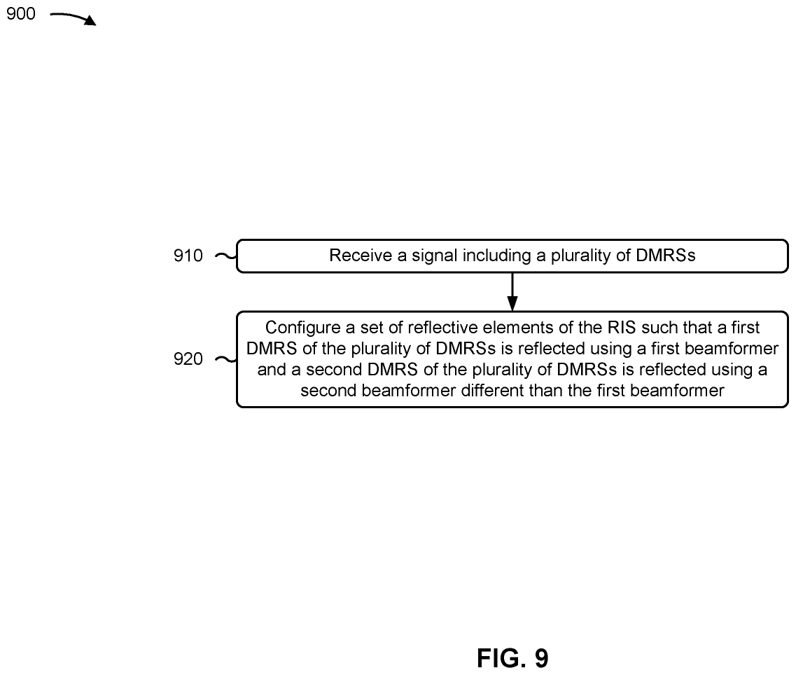

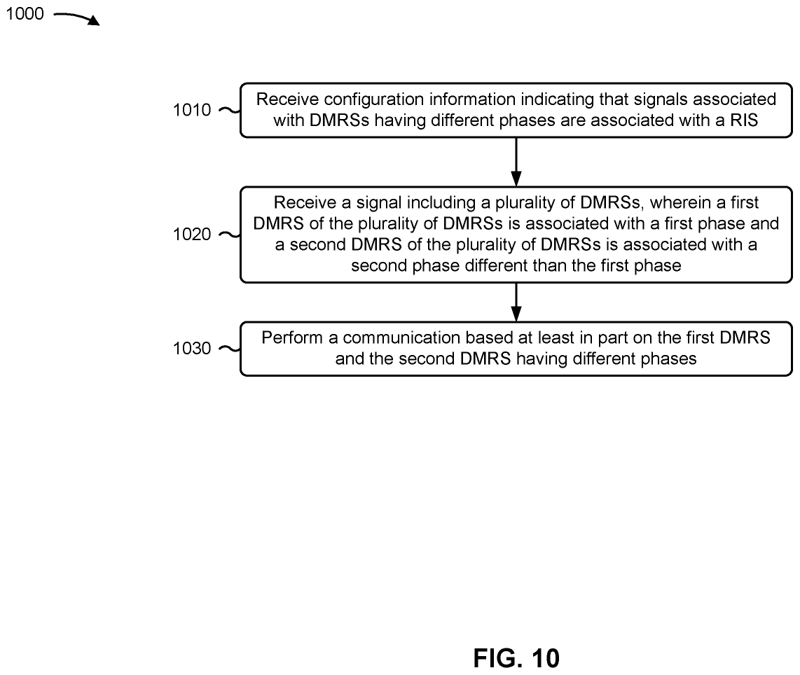

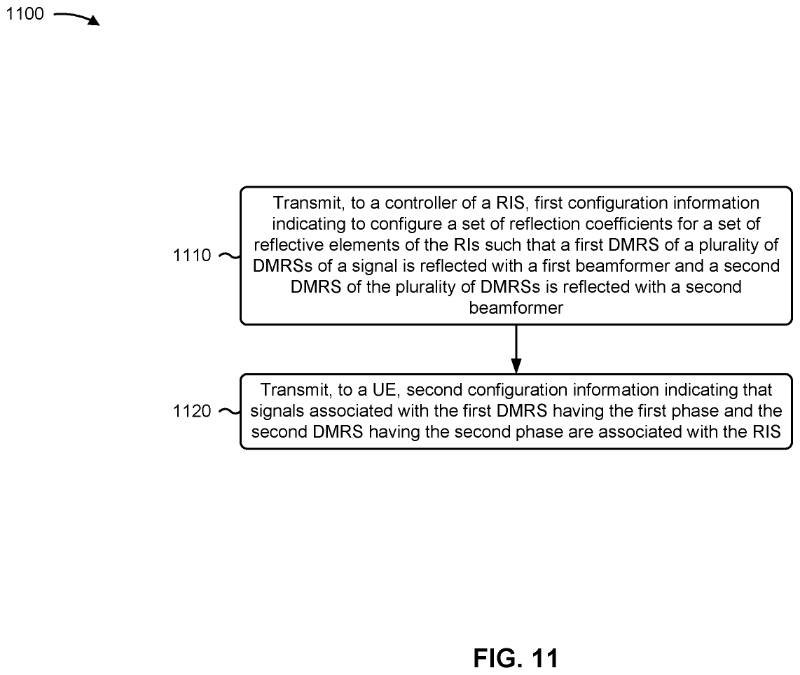

The controller/processor 240 of the base station 110, the controller/processor 280 of the UE 120, and/or any other component(s) of FIG. 2 may perform one or more techniques associated with indication of RIS participation in a communication, as described in more detail elsewhere herein. In some aspects, the RIS 140 described herein is the UE 120, is included in the UE 120, or includes one or more components of the UE 120 shown in FIG. 2. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, process 1100 of FIG. 11, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, UE 120 may include means for receiving configuration information indicating that signals associated with demodulation reference signals (DMRSs) having different phases are associated with RIS, means for receiving a signal including a plurality of DMRSs, wherein a first DMRS of the plurality of DMRSs is associated with a first phase and a second DMRS of the plurality of DMRSs is associated with a second phase different than the first phase, means for performing a communication based at least in part on the first DMRS and the second DMRS having different phases, or the like. In some aspects, such means may include one or more components of UE 120 described in connection with FIG. 2, such as controller/processor 280, transmit processor 264, TX MIMO processor 266, antenna 252, modem 254, MIMO detector 256, receive processor 258, or the like.

In some aspects, base station 110 may include means for transmitting, to a controller of a RIS, first configuration information indicating to configure a set of reflection coefficients for a set of reflective elements of the RIS such that a first DMRS of a plurality of DMRSs of a signal is reflected using a first beamformer and a second DMRS of the plurality of DMRSs is reflected using a second beamformer, wherein the first beamformer is associated with a first phase and the second beamformer is associated with a second phase, means for transmitting, to a UE, second configuration information indicating that signals associated with the first DMRS having the first phase and the second DMRS having the second phase are associated with the RIS, or the like. In some aspects, such means may include one or more components of base station 110 described in connection with FIG. 2, such as antenna 234, MIMO detector 236, receive processor 238, controller/processor 240, transmit processor 220, TX MIMO processor 230, modem 232, antenna 234, or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the UEs 305 may each include a communication manager 150, as described elsewhere herein. In some aspects, the one or more sidelink channels 310 may use a PC5 interface and/or may operate in a high frequency band (e.g., the 5.9 GHZ band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QOS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a transmission mode where resource selection and/or scheduling is performed by the UE 305 (e.g., rather than a base station 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

In some aspects, a communication may include one or more demodulation reference signals (DMRS). A DMRS is a signal that is included in one or more resources of a communication. A DMRS enables a receiver of the communication to demodulate the communication more effectively by providing a reference signal for the purpose of channel estimation. DMRSs are shown in example 300 in a resource block conveyed via a PSSCH 320, but can be included in any sidelink channel or any uplink or downlink channel. In some cases, a RIS (e.g., RIS 140) may relay or reflect transmissions between the UEs 305. The techniques and apparatuses described herein provide for manipulation of phase of the DMRSs such that the receiver of an SL communication can tell that the corresponding signal was reflected by a RIS.

As indicated above, FIG. 3 is provided as an example. Other examples may differ from what is described with respect to FIG. 3.

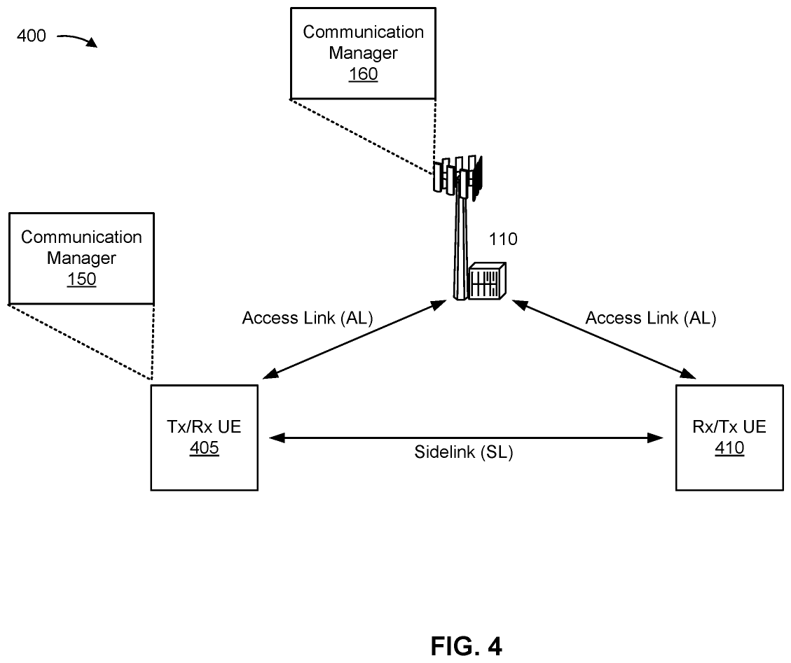

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate (e.g., utilizing communication managers 150) with one another via a sidelink, as described above in connection with FIG. 3. In some cases, the sidelink may propagate via an RIS. As further shown, in some sidelink modes, a base station 110 may communicate with the Tx/Rx UE 405 via a first access link (e.g., utilizing communication manager 160). Additionally, or alternatively, in some sidelink modes, the base station 110 may communicate with the Rx/Tx UE 410 via a second access link (e.g., utilizing communication manager 160). In some cases, the first access link and/or the second access link may propagate via an RIS (e.g., RIS 140), which may introduce a phase shift in one or more parts of a signal so that the propagation of the signal via the RIS is detectable to a receiver of the signal. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

FIG. 5 is a diagram illustrating a surface 510 and a controller 520 of a RIS 140, in accordance with the present disclosure. Some wireless communication systems have used active antenna units (AAUs) to increase throughput and increase quantities of wireless devices (e.g., UEs) that can be served by the wireless communication system. In some cases, AAUs may be communicatively coupled with a base station and may relay (e.g., reflect) transmissions between the base station and UEs. In this regard, AAUs may provide for high beamforming gain for communications within the wireless communication system and may enable a base station to circumvent obstructions which would otherwise interrupt wireless communication. However, AAUs may result in high power consumption and may therefore be undesirable for widespread use. One alternative to an AAU is a RIS 140. In some aspects, a RIS 140 may relay (e.g., reflect) transmissions between base stations and/or UEs via one or more reflective surface elements 530. As compared to AAUs, RISs are passive devices. Therefore, RISs may be associated with little to no power consumption, thereby improving power efficiency of the network.

An RIS 140 may reflect RF signals (e.g., an impinging wave) incident on the surface 510. The reflective property of a RIS 140 may be used to relay the RF signals from a transmitting device to a receiving device. Thus, a RIS 140 may be used to increase throughput, improve beamforming gain, and circumvent obstructions to increase a quantity of UEs that can be served by the network. A direction (such as an angle of reflection) and phase of the reflection of the RF signals can be controlled by a set of reflective elements 530. Nine reflective elements 530 are shown in FIG. 5, though the RIS 140 can include any number of reflective elements. The RIS 140 may be said to be “reconfigurable” because a phase and/or angle of reflection of signals incident on each of the reflective elements 530, and therefore an accumulative phase and/or angle of reflection of RF signals incident on the RIS 140, may be selectively adjustable. In particular, a precoder configuration (e.g., reflection matrix configuration) associated with the RIS 140 may include a set of precoders associated with the set of reflective elements 530, where each reflective element 530 is associated with a respective precoder.

In some aspects, the RIS 140 may be associated with a set of precoder configurations, where each precoder configuration may be represented by a vector r including a quantity of terms rᵢ representing precoders or reflective coefficients, and where i is equivalent to a quantity of reflective elements 530 of the RIS 140. In other words, a vector r for a RIS 140 including nine reflective surface elements 210 (e.g., i=9) may include nine terms (e.g., r₁ through r₉). Due to the fact that the RIS 140 includes a passive device which does not perform any signal amplification, each term rᵢ may include a complex number satisfying |rᵢ|≤1. In some aspects, the vector r may be used to generate a diagonal matrix R, in which the diagonal elements of R include the terms rᵢ of the vector r. In some aspects, the diagonal matrix R may be referred to as a precoder matrix of the reconfigurable surface 205-a. A precoder matrix (e.g., for a given UE 120 or a given direction), which may be referred to herein as a reflective matrix, is represented by the symbol φ. −φ (negative phi) indicates a reflective matrix with a phase rotation of π radians. The reflective matrix for a given UE 120 or a given direction may be obtained by configuration of the RIS 140 (such as by the base station 110) and/or by training.

In some aspects, the phase and/or angle of reflection for each reflective element 530 may be adjusted by adjusting a resistance, a reactance, or both, of each respective reflective element 530. Accordingly, a precoder associated with each reflective element 530 may include a set of parameters associated with the reflective element 530, including an orientation of the reflective element 530, a resistance and/or reactance of the reflective element 530, or any combination thereof. In this regard, the RIS 140 may be configured (by the controller 520) to modify an angle of reflection of signals incident on the RIS 140 based on the precoders associated with each of the reflective elements 530, by modifying a precoder configuration used by the RIS 140, by transitioning from a first precoder configuration to a second precoder configuration, or any combination thereof.

In addition to angle of reflection (used interchangeably herein with “direction”), the RIS 140 may be capable of modifying the phase of a reflected RF signal. The phase of the reflected RF signal may be controlled by the reflective elements 530 and may be specified by the reflective matrix. The phase of a reflected RF signal can be modified without modifying the direction of the reflected RF signal if the relative phase of each of the reflective elements 530 (relative to each other) is held constant. For example, a first RF signal can be transmitted with a phase of 0 radians and a second RF signal can be transmitted with a phase of π radians if the collective phase of the reflective elements 530 is modified to reflect the second RF signal with the phase of π radians (so long as the phases of the reflective elements 530 relative to each other are held constant). This difference in phase can be used to communicate information via a reflected RF signal, as described in more detail elsewhere herein.

The controller 520 may control the reflective elements 530 of the surface 510. For example, the controller 520 may select the reflective matrix used to configure the reflective elements 530. Additionally, the controller 520 may apply a set of parameters associated with each reflective element 530, as specified by the reflective matrix, to the reflective elements 530. For example, the controller 520 may configure an orientation of a reflective element 530, a resistance and/or reactance of the reflective element 530, or the like. The controller 520 may select a reflective matrix based at least in part on a timeline. For example, the controller 520 may receive configuration information indicating a time at which a particular reflective matrix is to be used or indicating a time at which a reflective matrix is to be modified. As one example, the techniques and apparatuses described herein provide for the controller 520 to apply a different reflective matrix for a first DMRS of a data channel (that is, at a time associated with the first DMRS) than for a second DMRS of the data channel (that is, at a time associated with the second DMRS) such that the second DMRS is phase rotated relative to the first DMRS.

In some aspects, the controller 520 may be capable of configuring multiple different reflective matrixes in sequence. For example, the controller 520 may use a first reflective matrix to direct a communication to a UE. The controller 520 may determine whether the communication was successfully directed to the UE (such as based at least in part on feedback received via an antenna 540, as described below). If the communication was not successfully directed to the UE, the controller 520 may use a second reflective matrix to direct the communication to the UE.

The controller 520 may include an antenna 540. For example, the controller 520 may include one or more components of an RF chain. The antenna 540 may enable communication with the base station 110 and/or the UE 120, such as via a radio access link or via a sidelink. For example, the base station 110 may provide configuration information (such as radio resource control (RRC) signaling, medium access control (MAC) signaling, control information, or the like) to the controller 520 via the radio access link. In some aspects, the configuration information may indicate a reflective matrix to be applied at a certain time or in accordance with a timeline.

In some aspects, the RIS 140 may include a communication manager 170. As described in more detail elsewhere herein, the communication manager 170 may perform one or more operations associated with RIS participation in a communication. Additionally, or alternatively, the communication manager 170 may perform one or more other operations described herein.

In some aspects, RIS 140 may include means for receiving a signal including a plurality of DMRSs, means for configuring a set of reflective elements of the RIS such that a first DMRS of the plurality of DMRSs is reflected using a first beamformer and a second DMRS of the plurality of DMRSs is reflected using a second beamformer different than the first beamformer, or the like. In some aspects, such means may include one or more components of the RIS 140, such as controller 520 or antenna 540. In some aspects, such means may include one or more components of the UE 120 described in connection with FIG. 2, such as controller/processor 280, transmit processor 264, TX MIMO processor 266, antenna 252, modem 254, MIMO detector 256, receive processor 258, or the like. In some aspects, such means may include one or more components of the base station 110 described in connection with FIG. 2, such as antenna 234, MIMO detector 236, receive processor 238, controller/processor 240, transmit processor 220, TX MIMO processor 230, modem 232, antenna 234, or the like.

The controller 520 may include a memory and one or more processors. The memory may be a non-transitory computer readable medium storing one or more instructions (e.g., code and/or program code) for wireless communications. For example, the one or more instructions, when executed (e.g., directly, or after compiling, converting, and/or interpreting) by the controller 520, may cause the controller 520 and/or the RIS 140 to perform or direct operations of, for example, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples.

As indicated above, FIG. 5 is provided as an example. Other examples may differ from what is described with regard to FIG. 5.

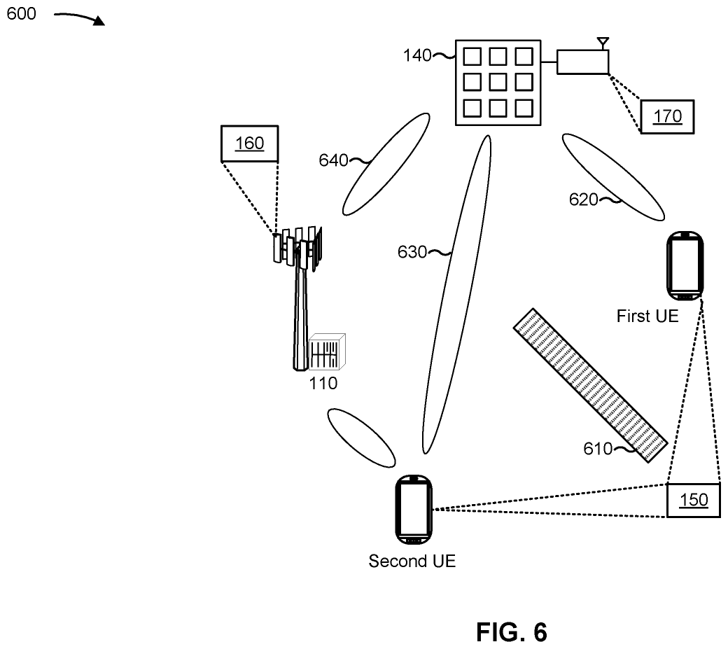

FIG. 6 is a diagram illustrating an example 600 of circumventing an obstacle 610 using a RIS 140, in accordance with the present disclosure. As shown in FIG. 6, example 600 includes communication between a base station 110, a first UE, and a second UE. In some aspects, the base station 110 (e.g., utilizing communication manager 160), the first UE (e.g., e.g., a first UE 120 utilizing communication manager 150), and the second UE (e.g., a second UE 120 utilizing communication manager 150) may be included in a wireless network, such as wireless network 100. In some aspects, the base station 110 and the first UE may communicate via a wireless access link, as described elsewhere herein. In some other aspects, the first UE may be out of coverage with respect to the base station 110. In some aspects, the base station 110 and the second UE may communicate via a wireless access link.

The first UE and the second UE may communicate via a wireless sidelink, as described elsewhere herein. As shown in FIG. 6, sidelink communication between the first UE and the second UE may be obstructed by an obstacle 610. Additionally, the obstacle 610 may interfere with access link communications between the base station 110 and the first UE, or the first UE may be out of coverage with respect to the base station 110.

In some cases, as shown in FIG. 6, a RIS 140 may be deployed to reflect RF signals (e.g., a beam) around the obstacle 610. The base station 110, the first UE, and/or the second UE may transmit, to the RIS 140, configuration information associated with configuring a set of reflective elements (e.g., reflective element 530) of the surface (e.g., surface 510) of the RIS 140. The RIS 140 (e.g., utilizing communication manager 170 or antenna 540) may receive the configuration information. The RIS 140 (e.g., using communication manager 170 or controller 520) may configure the set of reflective elements of the surface of the RIS 140 based at least in part on the configuration information.

In some aspects, the configuration information may be associated with access link communications. For example, the base station 110 may transmit configuration information indicating that the RIS 140 is to configure the set of reflective elements of the surface of the RIS 140 such that access link communications received from the first UE are reflected towards the base station 110 and/or that access link communications received from the base station 110 are reflected towards the first UE. The RIS 140 may configure, based at least in part on the configuration information, the set of reflective elements such that access link communications transmitted by the first UE (e.g., RF signal 620, as shown in FIG. 6) are reflected towards the base station 110 and access link communications transmitted by the base station 110 (e.g., RF signal 640, as shown in FIG. 6) are reflected towards the first UE.

In some aspects, the configuration information may be associated with sidelink communications between the first UE and the second UE. For example, the first UE may transmit configuration information indicating that the RIS 140 is to configure the set of reflective elements of the surface of the RIS 140 such that sidelink communications received from the first UE are reflected towards the second UE and/or sidelink communications received from the second UE are reflected towards the first UE. The RIS 140 may configure, based at least in part on the configuration information, the set of reflective elements such that sidelink communication transmitted by the first UE (e.g., RF signal 620, as shown in FIG. 6) are reflected towards the second UE and the sidelink communications transmitted by the second UE (e.g., RF signal 630, as shown in FIG. 6) are reflected towards the first UE. Thus, RF signals 620 can be reflected to or from the first UE so long as the RIS 140 is capable of steering the RF signals to the first UE, irrespective of whether the RF signals 620 are associated with the base station 110 or the second UE. Additionally, the RIS 140 may be capable of directing communications to different UEs, such as on a time division multiplexed basis.

In some cases, the sidelink communication between the first UE and the second UE may share the same spectrum as other communications in the cellular link (e.g., the uplink of the access link communications). In some cases, the first UE may determine resource allocation for the sidelink based at least in part on mode 2 resource allocation, as described elsewhere herein. For example, the first UE may measure an RSRP signal on a frequency resource and may determine that the resource is reserved when the measured RSRP signal satisfies (e.g., is greater than) a threshold.

However, when an RIS is deployed, the set of reflective elements on the surface of the RIS can be dynamically configured such that the RIS may oscillate between being active or on (e.g., reflecting RF signals received at the RIS) and inactive or off (e.g., not reflecting signals received at the RIS). The oscillation of the RIS between being on and off may impact the channel strength on a communication link, thereby causing sensing results obtained by the first UE unreliable. Further, the oscillation of the RIS between being on and off may cause a channel quality of a sidelink to experience significant changes over time, thereby limiting the usefulness of CSI feedback and power control.

Some techniques and apparatuses described herein enable a wireless node (e.g., any recipient of a communication reflected via a RIS) to determine whether a RIS is participating in a communication. In some aspects, a RIS may receive configuration information indicating that the RIS is to configure the set of reflective elements of the surface of the RIS such that a first DMRS, of a plurality of DMRSs included in a signal, is reflected with the first phase and a second DMRS, of the plurality of DMRSs, is reflected with a second, different phase. A UE may receive a signal including the plurality of DMRSs. The UE may determine that the first DMRS is associated with a first phase and that the second DMRS is associated with a second phase that is different than the first phase. The UE may determine that an RIS is participating in the communication based at least in part on the first DMRS is associated with a phase that is different than a phase associated with the second DMRS. As a result, the UE may be able to determine whether sensing results determined by the UE for allocating sidelink resources are impacted by the RIS participating in the communication. In this way, accuracy of CSI feedback and power control are improved.

As indicated above, FIG. 6 is provided as an example. Other examples may differ from what is described with regard to FIG. 6.

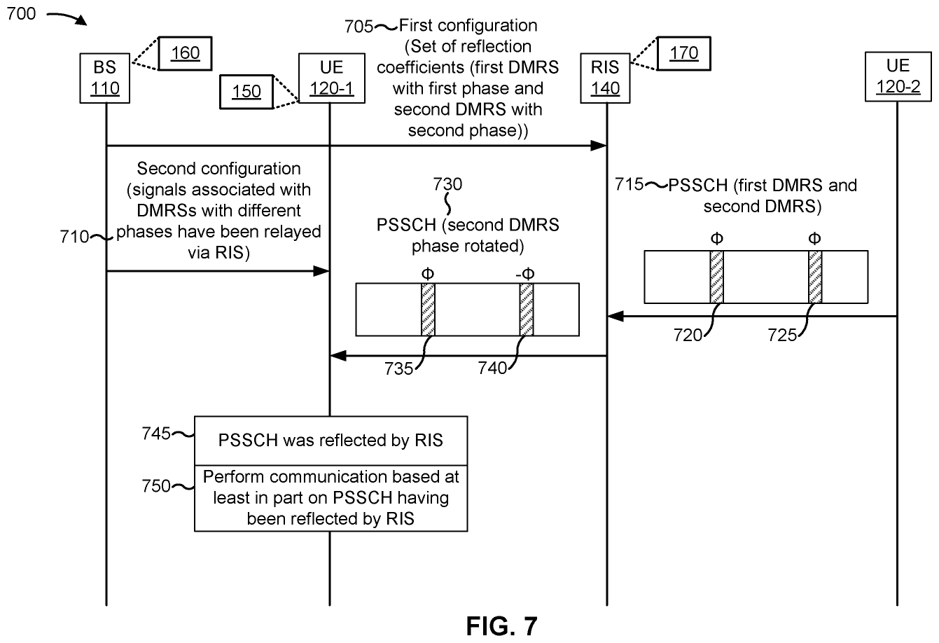

FIG. 7 is a diagram illustrating an example 700 associated with an indication of RIS participation in a communication, in accordance with the present disclosure. As shown in FIG. 7, example 700 includes an RIS 140 (e.g., utilizing communication manager 170) participating in communications between a base station 110 (e.g., utilizing communication manager 160), a first UE 120-1 (e.g., utilizing a first communication manager 150), and a second UE 120-2 (e.g., potentially utilizing a second communication manager 150 (not shown)). In some aspects, the base station 110, the first UE 120-1, the second UE 120-2, and the RIS 140 may be included in a wireless network, such as wireless network 100.

As shown by reference number 705, the base station 110 may transmit first configuration information to the RIS 140. The base station 110 may transmit the first configuration information via RRC signaling, medium access signaling, or the like.

In some aspects, the first configuration information may indicate that the RIS 140 (e.g., controller 520) is to configure a set of reflective elements (e.g., reflective element 530) of a surface (e.g., surface 510) of the RIS 140 such that a first DMRS, of a plurality of DMRSs included in a signal, is reflected using a first beamformer associated with a first phase and a second DMRS, of the plurality of DMRSs, is reflected using a second beamformer associated with a second phase that is different from the first phase. For example, the first configuration information may indicate one or more DMRSs, of the plurality of DMRSs, that are associated with the first beamformer and/or the first phase and one or more DMRSs, of the plurality of DMRSs, that are associated with the second beamformer and/or the second phase. More particularly, the first configuration information may indicate a first time associated with the one or more DMRSs that are associated with the first beamformer and/or the first phase and a second time associated with the one or more DMRSs that are associated with the second beamformer and/or the second phase, such that the RIS 140 can utilize the first beamformer and/or apply the first phase at the first time and utilize the second beamformer and/or apply the second phase at the second time.

In some aspects, the first configuration information indicates that a set of reflection coefficients for the set of reflective elements of the surface of the RIS 140 are to be configured such that the first DMRS is reflected with the first phase and the second DMRS is reflected with a second phase that is different than the first phase. In some aspects, a difference between the first phase and the second phase is pi (x) radians. In some aspects, a difference other than pi radians can be used. In some aspects, the first configuration information indicates one or more DMRSs, of the plurality of DMRSs, that are associated with the first phase (e.g., the first DMRS) and one or more DMRSs, of the plurality of DMRSs, that are associated with the second phase (e.g., the second DMRS). In some aspects, the configuration information indicates that a first reflective matrix is to be used for the first DMRS and a second reflective matrix is to be used for the second DMRS.

The RIS 140 may receive the first configuration information from the base station 110. The RIS 140 may configure the set of reflective elements based at least in part on the first configuration information. The RIS 140 may configure the set of reflective elements of the surface of the RIS 140 such that, after reflection by the surface of the RIS 140, the first DMRS, of the plurality of DMRSs, has the first phase and the second DMRS, of the plurality of DMRSs, has the second phase. In some aspects, the first DMRS occurs, in time, before the second DMRS. For example, the RIS 140 may receive the first DMRS at a first time and may receive the second DMRS at a second time that is subsequent to the first time. In some aspects, the first DMRS occurs, in time, after the second DMRS. For example, the RIS 140 may receive the first DMRS at a first time and may receive the second DMRS at a second time that is prior to the first time.

In some aspects, the RIS 140 may configure a first reflective matrix to be used for the first DMRS and a second reflective matrix to be used for the second DMRS. In some aspects, a difference between the first phase and the second phase may be pi (π) radians. In some aspects, a remainder of the signal (e.g., a portion of the signal other than the first DMRS and the second DMRS) has the first phase. In some aspects, the RIS 140 may continue to configure the set of reflective elements based at least in part the first configuration information until the RIS 140 receives other configuration information (e.g., second configuration information, as described elsewhere herein).

As shown by reference number 710, the base station 110 may transmit to the first UE 120-1 second configuration information indicating that signals associated with DMRSs having different phases have been relayed via the RIS 140. The base station 110 may transmit the second configuration information via RRC signaling, medium access signaling, downlink control information, or the like. In some aspects, the second configuration information indicates one or more DMRSs, of the plurality of DMRSs, that are associated with the first phase (e.g., the first DMRS) and one or more DMRSs, of the plurality of DMRSs, that are associated with the second phase (e.g., the second DMRS).

As shown by reference number 715, the second UE 120-2 may transmit a signal (e.g., a sidelink communication via a PSSCH, as described elsewhere herein). In some aspects, the signal may include a plurality of DMRSs. For example, as shown in FIG. 7, the signal may include the first DMRS (indicated by reference number 720) and the second DMRS (indicated by reference number 725). As further shown in FIG. 7, the first DMRS and the second DMRS have the same phase (Φ) (e.g., the first phase).

The RIS 140 may receive the signal from the second UE 120-2 and may reflect the signal towards the first UE 120-1. As shown by reference number 730, the signal may be reflected such that the first DMRS has the first phase (Φ) (as indicated by reference number 735) and the second DMRS has the second, different phase (−Φ) (as indicated by reference number 740).

The first UE 120-1 may receive the signal and, as shown by reference number 745, may determine that the signal was reflected by the RIS 140. In some aspects, the first UE 120-1 may determine that the signal was reflected by the RIS 140 based at least in part on determining that the first DMRS is associated with the first phase (Φ) and that the second DMRS is associated with the second, different phase (−Φ).

In some aspects, the first UE 120-1 determines that the first DMRS is associated with the first phase (Φ), and the second DMRS is associated with the second phase (−Φ) based at least in part on a first hypothesis corresponding to DMRSs associated with the same phase and a second hypothesis corresponding to DMRSs associated with different phases. When the RIS 140 is participating in a communication, a first symbol of the received signal corresponding to the first DMRS may be represented as:

H_{RIS-UE}ΦH_{gNB-RIS}x+H_{gNB-UE}x.

When the RIS 140 is participating in a communication, a second symbol of the received signal corresponding to the second DMRS may be represented as:

−H_{RIS-UE}ΦH_{gNB-RIS}x+H_{gNB-UE}x.

When the RIS 140 is not participating in a communication, a first symbol of the received signal corresponding to the first DMRS may be represented as:

H_{gNB-UE}x.

When the RIS 140 is not participating in a communication, a second symbol of the received signal corresponding to the second DMRS may also be represented as:

H_{gNB-UE}x.

In some aspects, the first UE 120-1 may determine whether a RIS is participating in a communication based at least in part on subtracting the second symbol from the first symbol. The first hypothesis may indicate that subtracting the second symbol from the first symbol may be equal to about zero based at least in part the first DMRS and the second DMRS having the same phase. The second hypothesis may indicate that subtracting the second symbol from the first symbol may result in 2H_{RIS-UE}ΦH_{gNB-RIS}x based at least in part on the first DMRS and the second DMRS having different phases.

As shown by reference number 750, the first UE 120-1 may perform communication based at least in part on the signal having been reflected by the RIS 140. For example, the first UE 120-1 may perform sensing of a channel strength associated with the channel between the first UE 120-1 and the second UE 120-2. As another example, the first UE 120 may determine and transmit CSI feedback based at least in part on the signal having been reflected by the RIS 140.

As indicated above, FIG. 7 is provided as an example. Other examples may differ from what is described with respect to FIG. 7.

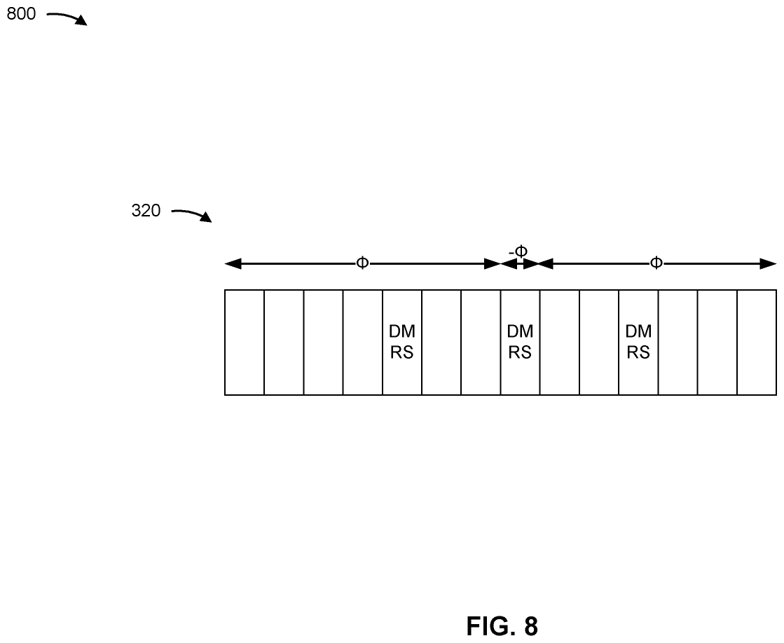

FIG. 8 is a diagram illustrating an example 800 associated with an indication of RIS participation in a communication, in accordance with the present disclosure. FIG. 8 indicates a change in a surface reflection matrix for an RIS over time with respect to a slot of a signal (e.g., PSSCH 320, as shown) based at least in part on the RIS configuring a set of reflective elements of the surface of the RIS such that, after reflection by the surface of the RIS, a first DMRS has a first phase and a second DMRS has a second phase that is different than the first phase.

As shown in FIG. 8, the set of reflective elements may be configured based at least in part on a first surface reflection matrix to reflect a first portion of the slot of the signal such that the first portion has a first phase (Φ). In some aspects, the first portion includes a first DMRS, of a plurality of DMRSs, transmitted via the signal.

As further shown in FIG. 8, the set of reflective elements may be configured based at least in part on a second surface reflection matrix to reflect a second portion of the slot of the signal such that the second portion has a second phase (−Φ) that is different from the first phase (Φ). In some aspects, the second portion includes only a second DMRS, of the plurality of DMRSs, transmitted via the signal.

As also shown in FIG. 8, the set of reflective elements may be configured based at least in part on the first surface reflection matrix to reflect a third portion of the slot of the signal such that the third portion has the first phase (Φ). In some aspects, the first portion is a remaining portion of the signal. In some aspects, as shown in FIG. 8, the third portion may include a third DMRS, of the plurality of DMRSs, transmitted via the signal.

As indicated above, FIG. 8 is provided as an example. Other examples may differ from what is described with respect to FIG. 8.

FIG. 9 is a diagram illustrating an example process 900 performed, for example, by a controller, in accordance with the present disclosure. Example process 900 is an example where the controller (e.g., a controller of RIS 140) performs operations associated with indication of RIS participation in a communication.

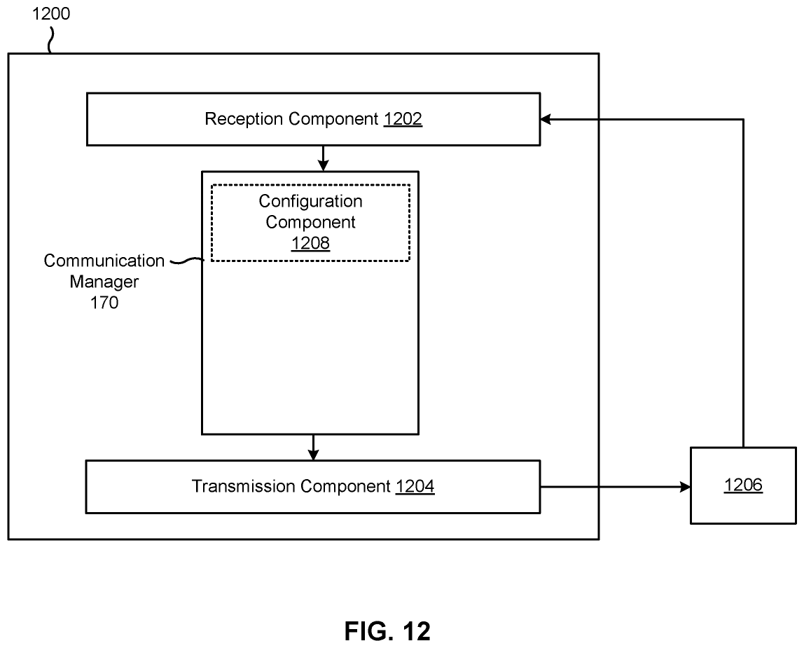

As shown in FIG. 9, in some aspects, process 900 may include receiving a signal including a plurality of DMRSs (block 910). For example, the controller (e.g., using communication manager 170 and/or reception component 1202, depicted in FIG. 12) may receive a signal including a plurality of DMRSs, as described above.

As further shown in FIG. 9, in some aspects, process 900 may include configuring a set of reflective elements of the RIS such that a first DMRS of the plurality of DMRSs is reflected using a first beamformer and a second DMRS of the plurality of DMRSs is reflected using a second beamformer different than the first beamformer (block 920). For example, the controller (e.g., using communication manager 170 and/or configuration component 1208, depicted in FIG. 12) may configure a set of reflective elements of the RIS such that a first DMRS of the plurality of DMRSs is reflected using a first beamformer and a second DMRS of the plurality of DMRSs is reflected using a second beamformer different than the first beamformer, as described above.

Process 900 may include additional aspects, such as any single aspect or any combination of aspects described below and/or in connection with one or more other processes described elsewhere herein.

In a first aspect, the first beamformer uses a first reflective matrix and the second beamformer uses a second reflective matrix.

In a second aspect, alone or in combination with the first aspect, a remainder of the signal, other than the first DMRS and the second DMRS, is reflected using the first beamformer.

In a third aspect, alone or in combination with one or more of the first and second aspects, the first DMRS occurs after the second DMRS in time.

In a fourth aspect, alone or in combination with one or more of the first through third aspects, the first beamformer is associated with a first phase and the second beamformer is associated with a second phase different than the first phase.

In a fifth aspect, alone or in combination with one or more of the first through fourth aspects, a difference between the first phase and the second phase is pi radians.

In a sixth aspect, alone or in combination with one or more of the first through fourth aspects, process 900 includes receiving first configuration information indicating to configure the set of reflective elements of the RIS such that the first DMRS is reflected with the first phase and the second DMRS is reflected with the second phase.

In a seventh aspect, alone or in combination with one or more of the first through sixth aspects, the first configuration information indicates one or more DMRSs, of the plurality of DMRSs, that are associated with the first phase and one or more DMRSs, of the plurality of DMRSs, that are associated with the second phase.

In an eighth aspect, alone or in combination with one or more of the first through seventh aspects, two or more of DMRSs of the plurality of DMRSs are associated with the first phase.

In a ninth aspect, alone or in combination with one or more of the first through eighth aspects, receiving the first configuration information comprises receiving the first configuration information via at least one of radio resource control signaling or medium access signaling.

In a tenth aspect, alone or in combination with one or more of the first through ninth aspects, process 900 includes continuing to configure the set of reflective elements in accordance with the first configuration information until other configuration information is received.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by an apparatus of a UE, in accordance with the present disclosure. Example process 1000 is an example where the apparatus (e.g., an apparatus of UE 120) performs operations associated with indication of RIS participation in a communication.

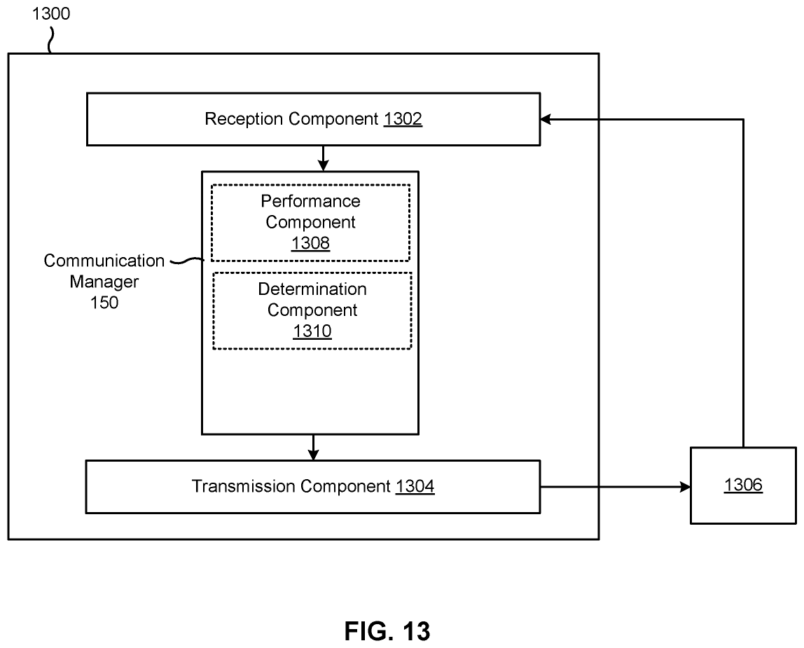

As shown in FIG. 10, in some aspects, process 1000 may include receiving configuration information indicating that signals associated with DMRSs having different phases are associated with a RIS (block 1010). For example, the apparatus (e.g., using communication manager 150 and/or reception component 1302, depicted in FIG. 13) may receive configuration information indicating that signals associated with DMRSs having different phases are associated with a RIS, as described above.

As further shown in FIG. 10, in some aspects, process 1000 may include receiving a signal including a plurality of DMRSs, wherein a first DMRS of the plurality of DMRSs is associated with a first phase and a second DMRS of the plurality of DMRSs is associated with a second phase different than the first phase (block 1020). For example, the apparatus (e.g., using communication manager 150 and/or reception component 1302, depicted in FIG. 13) may receive a signal including a plurality of DMRSs, wherein a first DMRS of the plurality of DMRSs is associated with a first phase and a second DMRS of the plurality of DMRSs is associated with a second phase different than the first phase, as described above.

As further shown in FIG. 10, in some aspects, process 1000 may include performing a communication based at least in part on the first DMRS and the second DMRS having different phases (block 1030). For example, the apparatus (e.g., using communication manager 150 and/or performance component 1308, depicted in FIG. 13) may perform a communication based at least in part on the first DMRS and the second DMRS having different phases, as described above.

Process 1000 may include additional aspects, such as any single aspect or any combination of aspects described below and/or in connection with one or more other processes described elsewhere herein.

In a first aspect, process 1000 includes determining that the signal has been reflected via a surface reflective of radio signals based at least in part on the first DMRS being associated with a different phase than the second DMRS.

In a second aspect, alone or in combination with the first aspect, a remainder of the signal, other than the first DMRS and the second DMRS, has the first phase.

In a third aspect, alone or in combination with one or more of the first and second aspects, the first DMRS occurs after the second DMRS in time.

In a fourth aspect, alone or in combination with one or more of the first through third aspects, a difference between the first phase and the second phase is pi radians.

In a fifth aspect, alone or in combination with one or more of the first through fourth aspects, receiving the configuration information further comprises receiving the configuration information via at least one of radio resource control signaling or medium access signaling.

In a sixth aspect, alone or in combination with one or more of the first through fifth aspects, the configuration information indicates one or more DMRSs, of the plurality of DMRSs, that are associated with the first phase and one or more DMRSs, of the plurality of DMRSs, that are associated with the second phase.

In a seventh aspect, alone or in combination with one or more of the first through sixth aspects, two or more DMRSs of the plurality of DMRSs are associated with the first phase.

In an eighth aspect, alone or in combination with one or more of the first through seventh aspects, process 1000 includes determining that the first DMRS is associated with the first phase and the second DMRS is associated with the second phase based at least in part on a first hypothesis corresponding to DMRSs associated with the same phase and a second hypothesis corresponding to DMRSs associated with different phases.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by an apparatus of a base station, in accordance with the present disclosure. Example process 1100 is an example where the apparatus (e.g., an apparatus of base station 110) performs operations associated with indication of RIS participation in a communication.

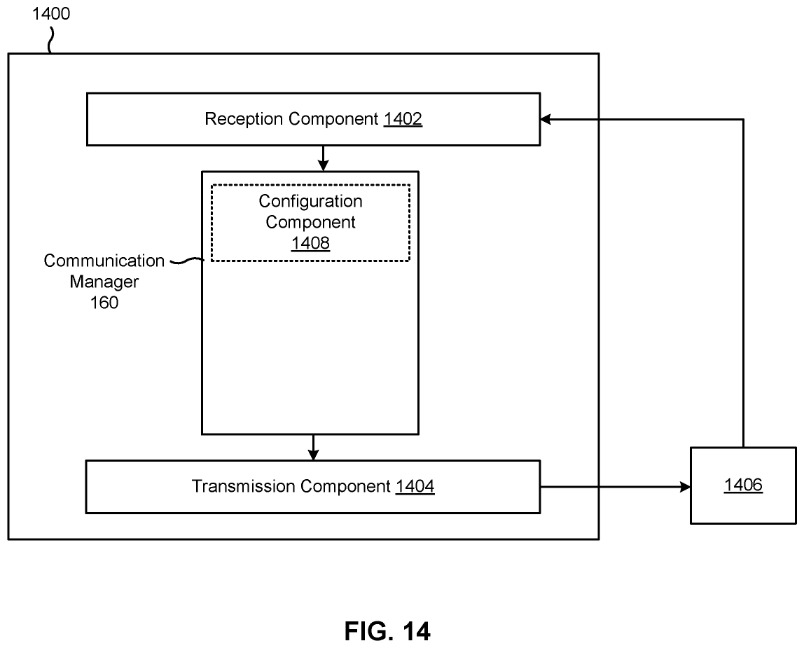

As shown in FIG. 11, in some aspects, process 1100 may include transmitting, to a controller of a RIS, first configuration information indicating to configure a set of reflection coefficients for a set of reflective elements of the surface such that a first DMRS of a plurality of DMRSs of a signal is reflected with a first beamformer and a second DMRS of the plurality of DMRSs is reflected with a second beamformer, wherein the first beamformer is associated with a first phase and the second beamformer is associated with a second phase (block 1110). For example, the apparatus (e.g., using communication manager 160 and/or transmission component 1404, depicted in FIG. 14) may transmit, to a controller of a RIS, first configuration information indicating to configure a set of reflection coefficients for a set of reflective elements of the surface such that a first DMRS of a plurality of DMRSs of a signal is reflected with a first beamformer and a second DMRS of the plurality of DMRSs is reflected with a second beamformer, wherein the first beamformer is associated with a first phase and the second beamformer is associated with a second phase, as described above.

As further shown in FIG. 11, in some aspects, process 1100 may include transmitting, to a UE, second configuration information indicating that signals associated with the first DMRS having the first phase and the second DMRS having the second phase are associated with the surface reflective of radio frequency signals (block 1120). For example, the apparatus (e.g., using communication manager 160 and/or transmission component 1404, depicted in FIG. 14) may transmit, to a user equipment (UE), second configuration information indicating that signals associated with the first DMRS having the first phase and the second DMRS having the second phase are associated with the surface reflective of radio frequency signals, as described above.

Process 1100 may include additional aspects, such as any single aspect or any combination of aspects described below and/or in connection with one or more other processes described elsewhere herein.

In a first aspect, the first configuration information indicates that a first reflective matrix is to be used for the first DMRS and a second reflective matrix is to be used for the second DMRS.

In a second aspect, alone or in combination with the first aspect, the first DMRS occurs after the second DMRS in time.

In a third aspect, alone or in combination with one or more of the first and second aspects, a difference between the first phase and the second phase is pi radians.

In a fourth aspect, alone or in combination with one or more of the first through third aspects, transmitting the first configuration information further comprises transmitting the first configuration information via at least one of radio resource control signaling or medium access signaling.

In a fifth aspect, alone or in combination with one or more of the first through fourth aspects, transmitting the second configuration information further comprises transmitting the second configuration information via at least one of radio resource control signaling or medium access signaling.

In a sixth aspect, alone or in combination with one or more of the first through fifth aspects, process 1100 includes transmitting other configuration information indicating to cease usage of the first configuration information.

In a seventh aspect, alone or in combination with one or more of the first through sixth aspects, the first configuration information and the second configuration information indicate one or more DMRSs, of the plurality of DMRSs, that are associated with the first phase and one or more DMRSs, of the plurality of DMRSs, that are associated with the second phase.

In an eighth aspect, alone or in combination with one or more of the first through seventh aspects, two or more DMRSs of the plurality of DMRSs are associated with the first phase.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be an RIS, or an RIS may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 170. The communication manager 170 may include a configuration component 1208, among other examples.

In some aspects, the apparatus 1200 may be configured to perform one or more operations described herein in connection with FIGS. 6-8. Additionally, or alternatively, the apparatus 1200 may be configured to perform one or more processes described herein, such as process 900 of FIG. 9, process 1000 of FIG. 10, process 1100 of FIG. 11, or a combination thereof. In some aspects, the apparatus 1200 and/or one or more components shown in FIG. 12 may include one or more components of the RIS described in connection with FIGS. 2 and 5. Additionally, or alternatively, one or more components shown in FIG. 12 may be implemented within one or more components described in connection with FIGS. 2 and 5. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1206. In some aspects, the reception component 1202 may include one or more antennas, a modem, a demodulator, a MIMO detector, a receive processor, a controller/processor, a memory, or a combination thereof, of the RIS described in connection with FIGS. 2 and 5.

The transmission component 1204 may transmit communications, such as reference signals, control information, data communications, or a combination thereof, to the apparatus 1206. In some aspects, one or more other components of the apparatus 1206 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the RIS described in connection with FIG. 2. In some aspects, the transmission component 1204 may be co-located with the reception component 1202 in a transceiver.

The reception component 1202 may receive a signal including a plurality of DMRSs. The configuration component 1208 may configure a set of reflective elements of the RIS such that a first DMRS of the plurality of DMRSs is reflected using a first beamformer and a second DMRS of the plurality of DMRSs is reflected using a second beamformer different than the first beamformer.

The reception component 1202 may receive first configuration information indicating to configure the set of reflective elements of the RIS such that the first DMRS is reflected with the first phase and the second DMRS is reflected with the second phase.

The configuration component 1208 may continue to configure the set of reflective elements in accordance with the first configuration information until other configuration information is received.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 150. The communication manager 150 may include one or more of a performance component 1308 and/or a determination component 1310, among other examples.

In some aspects, the apparatus 1300 may be configured to perform one or more operations described herein in connection with FIGS. 6-8. Additionally, or alternatively, the apparatus 1300 may be configured to perform one or more processes described herein, such as process 900 of FIG. 9, process 1000 of FIG. 10, process 1100 of FIG. 11, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1306. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1306 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The reception component 1302 may receive configuration information indicating that signals associated with DMRSs having different phases are associated with a RIS. The reception component 1302 may receive a signal including a plurality of DMRSs, wherein a first DMRS of the plurality of DMRSs is associated with a first phase and a second DMRS of the plurality of DMRSs is associated with a second phase different than the first phase. The performance component 1308 may perform a communication based at least in part on the first DMRS and the second DMRS having different phases.

The determination component 1310 may determine that the signal has been reflected via a surface reflective of radio signals based at least in part on the first DMRS being associated with a different phase than the second DMRS.

The determination component 1310 may determine that the first DMRS is associated with the first phase and the second DMRS is associated with the second phase based at least in part on a first hypothesis corresponding to DMRSs associated with the same phase and a second hypothesis corresponding to DMRSs associated with different phases.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a base station, or a base station may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 160. The communication manager 160 may include a configuration component 1408, among other examples.

In some aspects, the apparatus 1400 may be configured to perform one or more operations described herein in connection with FIGS. 6-8. Additionally, or alternatively, the apparatus 1400 may be configured to perform one or more processes described herein, such as process 900 of FIG. 9, process 1000 of FIG. 10, process 1100 of FIG. 11, or a combination thereof. In some aspects, the apparatus 1400 and/or one or more components shown in FIG. 14 may include one or more components of the base station described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1406. In some aspects, the reception component 1402 may include one or more antennas, a modem, a demodulator, a MIMO detector, a receive processor, a controller/processor, a memory, or a combination thereof, of the base station described in connection with FIG. 2.

The transmission component 1404 may transmit communications, such as reference signals, control information, data communications, or a combination thereof, to the apparatus 1406. In some aspects, one or more other components of the apparatus 1406 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the base station described in connection with FIG. 2. In some aspects, the transmission component 1404 may be co-located with the reception component 1402 in a transceiver.

The transmission component 1404 may transmit, to a controller of a RIS, first configuration information indicating to configure a set of reflection coefficients for a set of reflective elements of the RIS such that a first DMRS of a plurality of DMRSs of a signal is reflected with a first phase and a second DMRS of the plurality of DMRSs is reflected with a second phase. The transmission component 1404 may transmit, to a UE, second configuration information indicating that signals associated with the first DMRS having the first phase and the second DMRS having the second phase are associated with the RIS.

The transmission component 1404 may transmit other configuration information (e.g., generated by configuration component 1408) indicating to cease usage of the first configuration information.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:
Aspect 1: A method of wireless communication performed by a controller of a RIS for wireless communication, comprising: receiving a signal including a plurality of demodulation reference signals (DMRSs); and configuring a set of reflective elements of the RIS such that a first DMRS of the plurality of DMRSs is reflected using a first beamformer and a second DMRS of the plurality of DMRSs is reflected using a second beamformer different than the first beamformer.
Aspect 2: The method of Aspect 1, wherein the first beamformer uses a first reflective matrix and the second beamformer uses a second reflective matrix.
Aspect 3: The method of one or more of Aspects 1 and 2, wherein a remainder of the signal, other than the first DMRS and the second DMRS, is reflected using the first beamformer.
Aspect 4: The method of one or more of Aspects 1 through 3, wherein the first DMRS occurs after the second DMRS in time.
Aspect 5: The method of one or more of Aspects 1 through 4, wherein the first beamformer is associated with a first phase and the second beamformer is associated with a second phase different than the first phase.
Aspect 6: The method of Aspect 5, wherein a difference between the first phase and the second phase is pi radians.
Aspect 7: The method of one or more of Aspects 5 and 6, further comprising: receiving first configuration information indicating to configure the set of reflective elements of the RIS such that the first DMRS is reflected with the first phase and the second DMRS is reflected with the second phase.
Aspect 8: The method of Aspect 7, wherein the first configuration information indicates one or more DMRSs, of the plurality of DMRSs, that are associated with the first phase and one or more DMRSs, of the plurality of DMRSs, that are associated with the second phase.
Aspect 9: The method of Aspect 5, wherein two or more DMRSs of the plurality of DMRSs are associated with the first phase.
Aspect 10: The method of Aspect 7, wherein receiving the first configuration information comprises receiving the first configuration information via at least one of radio resource control signaling or medium access signaling.
Aspect 11: The method of one or more of Aspects 1 through 10, further comprising: continuing to configure the set of reflective elements in accordance with the first configuration information until other configuration information is received.
Aspect 12: A method of wireless communication performed by an apparatus of a UE, comprising: receiving configuration information indicating that signals associated with DMRSs having different phases are associated with a RIS; receiving a signal including a plurality of DMRSs, wherein a first DMRS of the plurality of DMRSs is associated with a first phase and a second DMRS of the plurality of DMRSs is associated with a second phase different than the first phase; and performing a communication based at least in part on the first DMRS and the second DMRS having different phases.
Aspect 13: The method of Aspect 12, further comprising: determining that the signal has been reflected via a surface reflective of radio signals based at least in part on the first DMRS being associated with a different phase than the second DMRS.
Aspect 14: The method of one or more of Aspects 12 and 13, wherein a remainder of the signal, other than the first DMRS and the second DMRS, has the first phase.
Aspect 15: The method of one or more of Aspects 12 through 14, wherein the first DMRS occurs after the second DMRS in time.
Aspect 16: The method of one or more of Aspects 12 through 15, wherein a difference between the first phase and the second phase is pi radians.
Aspect 17: The method of one or more of Aspects 12 through 16, wherein receiving the configuration information further comprises receiving the configuration information via at least one of radio resource control signaling or medium access signaling.
Aspect 18: The method of one or more of Aspects 12 through 17, wherein the configuration information indicates one or more DMRSs, of the plurality of DMRSs, that are associated with the first phase and one or more DMRSs, of the plurality of DMRSs, that are associated with the second phase.
Aspect 19: The method of one or more of Aspects 12 through 18, wherein two or more DMRSs of the plurality of DMRSs are associated with the first phase.
Aspect 20: The method of one or more of Aspects 12 through 19, further comprising: determining that the first DMRS is associated with the first phase and the second DMRS is associated with the second phase based at least in part on a first hypothesis corresponding to DMRSs associated with the same phase and a second hypothesis corresponding to DMRSs associated with different phases.
Aspect 21: A method of wireless communication performed by an apparatus of a base station, comprising: transmitting, to a controller of a RIS, first configuration information indicating to configure a set of reflection coefficients for a set of reflective elements of the surface such that a first DMRS of a plurality of DMRSs of a signal is reflected with a first beamformer and a second DMRS of the plurality of DMRSs is reflected with a second beamformer, wherein the first beamformer is associated with a first phase and the second beamformer is associated with a second phase; and transmitting, to a UE, second configuration information indicating that signals associated with the first DMRS having the first phase and the second DMRS having the second phase are associated with the surface reflective of radio frequency signals.
Aspect 22: The method of Aspect 21, wherein the first configuration information indicates that a first reflective matrix is to be used for the first DMRS and a second reflective matrix is to be used for the second DMRS.
Aspect 23: The method of one or more of Aspects 21 and 22, wherein the first DMRS occurs after the second DMRS in time.
Aspect 24: The method of one or more of Aspects 21 through 23, wherein a difference between the first phase and the second phase is pi radians.
Aspect 25: The method of one or more of Aspects 21 through 24, wherein transmitting the first configuration information further comprises transmitting the first configuration information via at least one of radio resource control signaling or medium access signaling.
Aspect 26: The method of one or more of Aspects 21 through 25, wherein transmitting the second configuration information further comprises transmitting the second configuration information via at least one of radio resource control signaling or medium access signaling.
Aspect 27: The method of one or more of Aspects 21 through 26, further comprising: transmitting other configuration information indicating to cease usage of the first configuration information.
Aspect 28: The method of one or more of Aspects 21 through 27, wherein the first configuration information and the second configuration information indicate one or more DMRSs, of the plurality of DMRSs, that are associated with the first phase and one or more DMRSs, of the plurality of DMRSs, that are associated with the second phase.
Aspect 29: The method of one or more of Aspects 21 through 28, wherein two or more DMRSs of the plurality of DMRSs are associated with the first phase.
Aspect 30: An apparatus for wireless communication at a device, comprising a processor; memory coupled with the processor; and instructions stored in the memory and executable by the processor to cause the apparatus to perform the method of one or more of Aspects 1 through 11.
Aspect 31: A device for wireless communication, comprising a memory and one or more processors coupled to the memory, the one or more processors configured to perform the method of one or more of Aspects 1 through 11.
Aspect 32: An apparatus for wireless communication, comprising at least one means for performing the method of one or more of Aspects 1 through 11.
Aspect 33: A non-transitory computer-readable medium storing code for wireless communication, the code comprising instructions executable by a processor to perform the method of one or more of Aspects 1 through 11.
Aspect 34: A non-transitory computer-readable medium storing a set of instructions for wireless communication, the set of instructions comprising one or more instructions that, when executed by one or more processors of a device, cause the device to perform the method of one or more of Aspects 1 through 11.
Aspect 35: An apparatus for wireless communication at a device, comprising a processor; memory coupled with the processor; and instructions stored in the memory and executable by the processor to cause the apparatus to perform the method of one or more of Aspects 12 through 20.
Aspect 36: A device for wireless communication, comprising a memory and one or more processors coupled to the memory, the one or more processors configured to perform the method of one or more of Aspects 12 through 20.
Aspect 37: An apparatus for wireless communication, comprising at least one means for performing the method of one or more of Aspects 12 through 20.
Aspect 38: A non-transitory computer-readable medium storing code for wireless communication, the code comprising instructions executable by a processor to perform the method of one or more of Aspects 12 through 20.
Aspect 39: A non-transitory computer-readable medium storing a set of instructions for wireless communication, the set of instructions comprising one or more instructions that, when executed by one or more processors of a device, cause the device to perform the method of one or more of Aspects 12 through 20.
Aspect 40: An apparatus for wireless communication at a device, comprising a processor; memory coupled with the processor; and instructions stored in the memory and executable by the processor to cause the apparatus to perform the method of one or more of Aspects 21 through 29.
Aspect 41: A device for wireless communication, comprising a memory and one or more processors coupled to the memory, the one or more processors configured to perform the method of one or more of Aspects 21 through 29.
Aspect 42: An apparatus for wireless communication, comprising at least one means for performing the method of one or more of Aspects 21 through 29.
Aspect 43: A non-transitory computer-readable medium storing code for wireless communication, the code comprising instructions executable by a processor to perform the method of one or more of Aspects 21 through 29.
Aspect 44: A non-transitory computer-readable medium storing a set of instructions for wireless communication, the set of instructions comprising one or more instructions that, when executed by one or more processors of a device, cause the device to perform the method of one or more of Aspects 21 through 29.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A controller of a reconfigurable intelligent surface (RIS) for wireless communication, comprising:
a memory; and
one or more processors, coupled to the memory, configured to:
receive a signal including a plurality of demodulation reference signals (DMRSs); and
configure a set of reflective elements of the RIS such that a first DMRS of the plurality of DMRSs is reflected using a first beamformer and a second DMRS of the plurality of DMRSs is reflected using a second beamformer different than the first beamformer.

2. The controller of claim 1, wherein the first beamformer uses a first reflective matrix and the second beamformer uses a second reflective matrix.

3. The controller of claim 1, wherein a remainder of the signal, other than the first DMRS and the second DMRS, is reflected using the first beamformer.

4. The controller of claim 1, wherein the first DMRS occurs after the second DMRS in time.

5. The controller of claim 1, wherein the first beamformer is associated with a first phase and the second beamformer is associated with a second phase different than the first phase.

6. The controller of claim 5, wherein a difference between the first phase and the second phase is pi radians.

7. The controller of claim 5, wherein the one or more processors are further configured to:
receive first configuration information indicating to configure the set of reflective elements of the RIS such that the first DMRS is reflected with the first phase and the second DMRS is reflected with the second phase.

8. The controller of claim 7, wherein the first configuration information indicates one or more DMRSs, of the plurality of DMRSs, that are associated with the first phase and one or more DMRSs, of the plurality of DMRSs, that are associated with the second phase.

9. The controller of claim 7, wherein two or more DMRSs of the plurality of DMRSs are associated with the first phase.

10. The controller of claim 7, wherein the one or more processors, to receive the first configuration information, are configured to receive the first configuration information via at least one of radio resource control signaling or medium access signaling.

11. The controller of claim 7, wherein the one or more processors are further configured to:
continue to configure the set of reflective elements in accordance with the first configuration information until other configuration information is received.

12. An apparatus for wireless communication at a user equipment (UE), comprising:
a memory; and
one or more processors, coupled to the memory, configured to:
receive configuration information indicating that signals associated with DMRSs having different phases are associated with a reconfigurable intelligent surface (RIS);
receive a signal including a plurality of DMRSs, wherein a first DMRS of the plurality of DMRSs is associated with a first phase and a second DMRS of the plurality of DMRSs is associated with a second phase different than the first phase; and
perform a communication based at least in part on the first DMRS and the second DMRS having different phases.

13. The apparatus of claim 12, wherein the one or more processors are further configured to:
determine that the signal has been reflected via a surface reflective of radio signals based at least in part on the first DMRS being associated with a different phase than the second DMRS.

14. The apparatus of claim 12, wherein a remainder of the signal, other than the first DMRS and the second DMRS, has the first phase.

15. The apparatus of claim 12, wherein the first DMRS occurs after the second DMRS in time.

16. The apparatus of claim 12, wherein a difference between the first phase and the second phase is pi radians.

17. The apparatus of claim 12, wherein the one or more processors, to receive the configuration information, are configured to receive the configuration information via at least one of radio resource control signaling or medium access signaling.

18. The apparatus of claim 12, wherein the configuration information indicates one or more DMRSs, of the plurality of DMRSs, that are associated with the first phase and one or more DMRSs, of the plurality of DMRSs, that are associated with the second phase.

19. The apparatus of claim 12, wherein two or more DMRSs of the plurality of DMRSs are associated with the first phase.

20. The apparatus of claim 12, wherein the one or more processors are further configured to:
determine that the first DMRS is associated with the first phase and the second DMRS is associated with the second phase based at least in part on a first hypothesis corresponding to DMRSs associated with the same phase and a second hypothesis corresponding to DMRSs associated with different phases.

21. An apparatus for wireless communication at a base station, comprising:
a memory; and
one or more processors, coupled to the memory, configured to:
transmit, to a controller of a reconfigurable intelligent surface (RIS), first configuration information indicating to configure a set of reflection coefficients for a set of reflective elements of the RIS such that a first demodulation reference signal (DMRS) of a plurality of DMRSs of a signal is reflected with a first beamformer and a second DMRS of the plurality of DMRSs is reflected with a second beamformer, wherein the first beamformer is associated with a first phase and the second beamformer is associated with a second phase; and
transmit, to a user equipment (UE), second configuration information indicating that signals associated with the first DMRS having the first phase and the second DMRS having the second phase are associated with the RIS.

22. The apparatus of claim 21, wherein the first configuration information indicates that a first reflective matrix is to be used for the first DMRS and a second reflective matrix is to be used for the second DMRS.

23. The apparatus of claim 21, wherein the first DMRS occurs after the second DMRS in time.

24. The apparatus of claim 21, wherein a difference between the first phase and the second phase is pi radians.

25. The apparatus of claim 21, wherein the one or more processors, to transmit the first configuration information, are configured to transmit the first configuration information via at least one of radio resource control signaling or medium access signaling.

26. The apparatus of claim 21, wherein the one or more processors, to transmit the second configuration information, are configured to transmit the second configuration information via at least one of radio resource control signaling or medium access signaling.

27. The apparatus of claim 21, wherein the one or more processors are further configured to:
transmit other configuration information indicating to cease usage of the first configuration information.

28. The apparatus of claim 21, wherein the first configuration information and the second configuration information indicate one or more DMRSs, of the plurality of DMRSs, that are associated with the first phase and one or more DMRSs, of the plurality of DMRSs, that are associated with the second phase.

29. The apparatus of claim 21, wherein two or more DMRSs of the plurality of DMRSs are associated with the first phase.

30. A method of wireless communication performed by a controller of a reconfigurable intelligent surface (RIS), comprising:
receiving a signal including a plurality of demodulation reference signals (DMRSs); and
configuring a set of reflective elements of the RIS such that a first DMRS of the plurality of DMRSs is reflected using a first beamformer and a second DMRS of the plurality of DMRSs is reflected using a second beamformer different than the first beamformer.
